(19) United States
(12) Patent Application Publication
(10) Pub. No.: US 2018/0250910 A1
(43) Pub. Date: Sep. 6, 2018

(54) CARPET TILES AND METHODS OF THEIR MANUFACTURE

(71) Applicant: Celanese International Corporation, Irving, TX (US)

(72) Inventor: David LUNSFORD, Fountain Inn, SC (US)

(21) Appl. No.: 15/450,317

(22) Filed: Mar. 6, 2017

(51) Int. Cl. B32B 5/02; B32B 7/12; B32B 37/12; B32B 27/06

(52) U.S. Cl. CPC B32B 5/028; B32B 7/12; B32B 37/12; B32B 2262/101; B32B 2419/04; B32B 2471/02; B32B 27/06

(57) ABSTRACT

A carpet tile comprises a primary backing layer comprising a flexible substrate with fiber tufts extending through and from one surface of the substrate to define, in use, the upper wear surface of the tile. A pre-coat adhesive layer formed from an aqueous copolymer dispersion is provided on the opposite surface of the primary backing substrate to secure the fiber tufts to the substrate and a secondary adhesive layer formed from an aqueous copolymer dispersion is provided on the pre-coat adhesive layer. A fiberglass scrim is secured to the secondary adhesive layer and an outer backing or cap layer covers the fiberglass scrim.

### FIELD

The present invention relates to carpet tiles and methods of their manufacture.

### BACKGROUND

Carpet tiles have recently become popular as a floor covering material. They offer many advantages over standard roll-type carpet floor covering. The tiles, which are generally 18 to 24 inches square but are also available as rectangular planks, can be laid over a floor or other area in a mosaic or grid pattern and can easily be individually removed for cleaning or replacement purposes, when individual tiles become soiled or worn. A complete or partial floor covering of carpet tiles is generally inexpensive over time because only the worn or soiled carpet tiles need be removed. The remaining unworn or unsoiled portion of the carpet may be saved and kept in place. Carpet tile also provides more flexibility in carpet design since tiles may be swiftly replaced with a different color to suit a particular occasion. Important properties of a carpet tile are dimensional stability and tuft bind strength (that is the amount of force required to physically pull a tuft through the primary backing layer).

Carpet tiles are typically composed of at least five layers: a tufted primary backing layer, a pre-coat adhesive layer, a secondary adhesive layer, a fiberglass scrim and an outer secondary backing layer. Most carpet tiles produced today employ an emulsion polymer as the pre-coat adhesive and either a polyvinyl chloride plastisol or an extruded polyolefin as the secondary backing system, that is the secondary adhesive layer and the outer secondary backing layer. Examples of carpet tiles with this five-layer construction are disclosed in, for example, EP590422A1.

In most carpet tile production processes, the pile yarn of the carpet tile is tufted through a woven or non-woven primary backing substrate so that the pile tufts project from the upper surface of the substrate to define the wear surface of the tile. The pile tufts are then anchored in place by the pre-coat adhesive layer, which is applied to the rear surface of the primary backing substrate and the tuft loops exposed on the rear surface of the substrate. This precoat layer is typically a VAE-based compounded emulsion but compounded PVC plastisols and compounded butadiene/methyl methacrylate emulsions can also be utilized. The scrim is provided to improve the dimensional stability of the carpet tile and is normally composed of a non-woven fiberglass mat that is adhered to the back of the precoated fabric layer with the secondary adhesive layer. This secondary adhesive layer is typically the same as the outer backing layer and together they form what is typically referred to as the secondary backing. The secondary backing layers may be in the form of a PVC plastisol, bitumen, polyurethane or an extruded polyolefin.

Carpet tile is typically manufactured as a continuous length of carpet and then cut with a press to a specific dimension to provide carpet tiles. In most manufacturing methods, the pre-coat adhesive is applied in a fluid state to the rear surface of the primary backing substrate and is then subjected to a first heat treatment step before any further manufacturing steps are carried out. Once the pre-coat adhesive has dried (for water based precoats) or fused (for PVCl plastiosol precoats), the adhesive layer, scrim and the final outer backing layer are applied to the pre-coated primary backing layer.

Although existing processes for manufacturing carpet tile are satisfactory, a major target for the carpet tile industry is lowering tile weight without sacrificing the integrity of the tile, particularly the tuft bind strength and dimensional stability.

### SUMMARY

According to the present invention, it had now been found that the total amount of adhesive required to produce carpet tiles of the type described above, and hence tile weight, can be decreased, without significant loss of tuft bind strength or dimensional stability, by employing an emulsion copolymer as the secondary adhesive and applying the secondary adhesive layer while the pre-coat adhesive is still wet, that is by omitting the first heat treatment step in the manufacturing method described above.

Thus, in one aspect, the invention resides in a carpet tile comprising:

(i) a primary backing layer comprising a flexible substrate with fiber tufts extending through and from one surface of the substrate to define, in use, the upper wear surface of the tile;

(ii) a pre-coat adhesive layer formed from an aqueous copolymer dispersion provided on the opposite surface of the primary backing substrate and securing the fiber tufts to the substrate;

(iii) a secondary adhesive layer formed from an aqueous copolymer dispersion provided on the pre-coat adhesive layer;

(iv) a fiberglass scrim secured to the secondary adhesive layer; and

(v) an outer backing or cap layer covering the fiberglass scrim.

In a further aspect, the invention resides in a method of manufacturing a carpet tile, the method comprising:

(a) providing a primary backing layer comprising a flexible substrate with fiber tufts extending through and from one surface of the substrate to define, in use, the upper wear surface of the tile;

(b) applying a pre-coat adhesive in liquid form to the opposite surface of the flexible substrate;

(c) while the pre-coat adhesive is still in liquid form, applying a water-based secondary adhesive in liquid form and a fiberglass scrim to the pre-coat adhesive on the primary backing layer;

(d) drying the pre-coat adhesive and the secondary adhesive; and then

(e) applying an outer backing or cap layer to the scrim.

### DETAILED DESCRIPTION

As used therein the term “carpet tile” refers to a discrete piece of fabric-based flooring material which, in contrast to broadloom carpet, is substantially restricted in length and width, such that in general multiple tiles are needed to completely cover a flooring surface. Carpet tiles are typically available in sizes in the range from 4 inches by 4 inches to 72 inches by 72 inches, generally 18 inches by 18 inches to 24 inches by 24 inches. The carpet tiles may be of the same length and width, thus forming a square shape. Or, the carpet tiles may have different dimensions such that the width and the length are not the same. For example, the carpet tiles may be a rectangular shape, such as 36 inches by 18 inches.

The carpet tiles disclosed herein comprise at least five layers. One outer layer of the tile is the primary backing layer which comprises a flexible substrate having a plurality of pile yarns tufted or needled through the substrate to form the exterior wear surface or pile of the carpet tile. The yarn tufts can be formed of wool or a synthetic fiber, such as nylon 6; nylon 6,6, polyester; or polypropylene. The yarn can be of any pile height and weight necessary to provide the required properties of the tile, for example texture and wearability. The primary backing substrate can be any woven or nonwoven substrate which provides the required dimensional stability of finished tile, such as non-woven polyester, or woven polyester, polypropylene, or nylon.

A pre-coat adhesive is applied to the rear surface of the primary backing substrate opposite the pile surface so that the yarn loops exposed on the rear surface of the substrate are embedded in the pre-coat adhesive, thereby securing the yarn tufts to the substrate. The pre-coat adhesive is applied to the rear surface of the primary backing substrate in liquid form, preferably as a water-based coating composition. Examples of suitable water-based coating compositions include one or more of a vinyl ester copolymer, an acrylate copolymer, a vinyl ester/acrylate copolymer, a styrene-acrylate copolymer, an acrylic-butadiene copolymer, and a styrene-butadiene copolymer. In one preferred embodiment, the pre-coat adhesive comprises an aqueous dispersion formed by emulsion polymerization of a vinyl ester of an alkanoic acid, the acid having from 1 to 13 carbon atoms, especially vinyl acetate, with 5 to 25%, preferably 5 to 15%, by weight of ethylene and optionally one or more further comonomers, such as ethylenically unsaturated co-monomers with at least one amide-, epoxy, hydroxyl, silane or carbonyl group. Typically, the pre-coat dispersion contains up to 400, for example 175 to 275, parts by weight, of one or more fillers, such as aluminum trihydrate, fly ash, ground glass, calcium carbonate, clay, kaolin, talc, barites, and feldspar, based on the 100 parts by weight dry copolymer. In some embodiments, the pre-coat dispersion has a viscosity from about 2500 cP to about 10,000 cP when measured with a Brookfield viscometer at room temperature (21° C.). Examples of suitable pre-coat dispersions are disclosed in U.S. Pat. Nos. 5,026,765; 5,849,389 and 6,359,076, the entire contents of which are incorporated herein by reference. When dried, the pre-coat adhesive forms the second layer of the present carpet tile.

Provided on the pre-coat adhesive layer is the third layer of the carpet tile, that is a secondary adhesive layer, again a dried form of a water-based coating composition. As in the case of the pre-coat adhesive, the secondary adhesive preferably comprises one or more of a vinyl ester copolymer, an acrylate copolymer, a vinyl ester/acrylate copolymer, a styrene-acrylate copolymer, an acrylic-butadiene copolymer and a styrene-butadiene copolymer. In one preferred embodiment, the secondary adhesive comprises an aqueous dispersion formed by emulsion polymerization of a vinyl ester of an alkanoic acid, the acid having from 1 to 13 carbon atoms, especially vinyl acetate, with about 5 to 30%, such as 5 to 20%, for example 5 to 15%, by weight of ethylene and optionally one or more further comonomers, such as ethylenically unsaturated co-monomers with at least one amide-, epoxy, hydroxyl, silane or carbonyl group. Typically, the pre-coat dispersion contains up to 300 parts, such as 100 to 200 parts, by weight of one or more fillers, such as aluminum trihydrate, fly ash, ground glass, calcium carbonate, clay, kaolin, talc, barites, and feldspar, based on the 100 parts by weight dry copolymer. In some embodiments, the pre-coat dispersion has a viscosity from about 25,000 to about 40,000 cP when measured with a Brookfield viscometer at room temperature (21° C.). Examples of suitable pre-coat dispersions are disclosed in U.S. Pat. Nos. 5,026,765; 5,849,389 and 6,359,076, the entire contents of which are incorporated herein by reference.

A fourth layer of the carpet tile is a non-woven scrim which is attached to the pre-coat adhesive layer of the tile to provide dimensional stability to the tile. The scrim is formed of a non-woven fiberglass matt. Examples of the type of fiber glass matt materials for use as the scrim are sold under the trade names Dura-Glass 7607, Dura-Glass 8507, Dura-Glass 8510 and Dura-Glass 8570, all manufactured and sold by Johns-Manville. Modified versions of these glass matts with a more open construction may also be used so as to facilitate water removal.

The fifth layer, of the carpet tile is an outer backing or cap layer which, in use, generally defines the floor-engaging surface of the tile and may comprise one or more of polyvinyl chloride, bitumen or an extruded polyolefin or polyurethane.

The carpet tile described above is produced by tufting or needling yarn into the woven or non-woven primary backing substrate and then applying the aqueous pre-coat adhesive to the rear of the substrate such that the portion of the yarn exposed on the substrate rear is embedded in the pre-coat adhesive. Then, without heat treating the pre-coated product to dry the pre-coat adhesive, the aqueous secondary coating composition and the scrim are applied to the wet pre-coat adhesive. The secondary coating composition and then the scrim can be applied sequentially to the pre-coated product or, more preferably the secondary adhesive layer can be applied to the scrim before both are applied to the pre-coated product such that pre-coat and secondary adhesive layers are in contact. The combination of the tufted primary backing, pre-coat adhesive, secondary adhesive and scrim is then heat treated to dry the pre-coat adhesive and the secondary adhesive thereby bonding the carpet tile layers together. Conveniently, heat treatment is effected by passing the pre-formed carpet product through an oven at a temperature of 100 to 180° C., such as 125 to 166° C. for a time from 2 to 10 minutes. Finally, the secondary backing layer is applied to the scrim to complete the carpet tile.

It is found that, by combining the secondary adhesive coating and scrim with the pre-coated product while the pre-coat adhesive is still wet, the strength of the adhesive bond between pre-coat and secondary adhesives is greatly improved. As a result, the total amount of adhesive required to produce the carpet tile and hence the overall weight of the carpet tile can be decreased, without significant loss of tuft bind strength or dimensional stability.

The invention will now be more particularly described with reference to the following, non-limiting Examples.

In the Examples, a series of carpet tile samples (approximately 8 inches by 12 inches) was prepared from an unbacked carpet precursor (the primary backing layer) with nylon face yarns and a nonwoven polyester tufting substrate. The carpet precursor had an uncoated weight of around 23 oz/sq yd. Different pre-coat and secondary adhesives layers were formulated and applied to the carpet precursor together with a scrim and an outer backing layer to produce the 5 layer carpet tiles described above. The bind strength of the nylon yard tufts was then determined by ASTM Test Method D1335.

The delamination strength of the outer backing layer was determined by a subjective test where the PVC plastisol layer was separated from fiberglass scrim with the samples judged on ease of separation. Samples that could not be separated without destruction of the layers were judged to be excellent while those that separated very easily were judged to be poor.

The tile samples were also tested for dimensional stability properties using a lab development test method. Commercial carpet tiles are tested using a dimensional stability test (such as ASTM D7570) where samples are exposed to variations in moisture and temperature through multiple cycles in order to test for dimensional changes in the carpet. Since the size of the current samples precluded the use of the standard industry test method, a modified test of dimensional stability was developed. The test is described below.

Finished, laboratory coated carpet samples were die cut to 4″×6″ and marked ¼″ from each edge along the 6″ width on the face of the carpet. Samples were immersed in room temperature (21° C.) water for 5 hours. Samples were allowed to partially drain and then placed face up on glass plates. The sample and glass plate were placed in an oven set to 100° C. for 18 hours to completely dry the sample. Samples were removed from the oven and glass plate and placed on a flat countertop. Data was collected at each corner using the pre-marked locations; measuring the distance in millimeters from the countertop to the bottom of the tile. Samples were them allowed to cool to room temperature and placed back on glass plates. Samples and plates were them placed in a conditioning chamber at 21° C. and 65% relative humidity for 1 hour. Samples were removed from conditioning chamber and glass plates and measured at each corner again for conditioned results. At both measurements, visual inspection of the overall samples was conducted, noting any doming that may have taken place that would not get captured in up-curl measurements. One immersion and drying step was considered one cycle. Testing through 3 cycles was done in order to provide a complete assessment of the dimensional stability of each sample produced. Each cycle will have a value before and after the 1 hr/65% RH/21° C. conditioning step.

In the case of pre-coat adhesives tested, the following Pre-coat Formulations 1 (with filler) and 2 (without filler) were produced using a series of different commercially-available emulsion binders as listed in Table 1.

Pre-coat Formulation 1

| | Parts by | |
|---|---|---|
| Ingredients | Weight (dry) | |
| Emulsion Binder | 100 | parts |
| Calcium Carbonate | 250 | parts |
| Ammonium Lauryl Sulfate | 0.6 | parts |

| | |
|---|---|
| Pre-neutralized Acrylic Thickener | as needed for viscosity = |
| | 5000-9000 cps |

Pre-coat Formulation 2

| | Parts by | |
|---|---|---|
| Ingredients | Weight (dry) | |
| Emulsion Binder | 100 | parts |
| Ammonium Lauryl Sulfate | 0.6 | parts |

| | |
|---|---|
| Pre-neutralized Acrylic Thickener | as needed for viscosity = |
| | 5000-9000 cps |

TABLE 1

| Polymer | | Trade Name | |
|---|---|---|---|
| No. | Polymer Type | if available | Supplier |
| 1 | Vinyl Acetate/Ethylene | TufCOR C-815 | Celanese |
| | Copolymer | | |
| 2 | Vinyl Acetate/Ethylene | Dur-O-Set TX-848 | Celanese |
| | Copolymer | | |
| 3 | Vinyl Acetate/ Acrylic | Avicor 7305 | Celanese |
| | Copolymer | | |
| 4 | Vinyl Acetate/ Acrylic | 75VA/25BA/0.08AA | Celanese |
| | Copolymer | copolymer - surfactant | |
| | | stabilized | |
| 5 | Methyl Methacylate/ | Foundations 807 | Trinseo |
| | Butadiene Copolymer | | |
| 6 | Styrene/Butadiene | Styron 8476 | Trinseo |
| | Copolymer | | |

In the case of the secondary adhesives tested, a series of Secondary Adhesive Formulations 1 were produced from the emulsion binders listed in Table 1, each formulation having the following composition:

Secondary Adhesive Formulation #1

| | Parts by | |
|---|---|---|
| Ingredients | Weight (dry) | |
| Emulsion Binder | 100 | parts |
| Calcium Carbonate Filler | 100 | parts |
| 2GRL Dye(color for tint) | 0.3 | parts |
| Ammonium Hydroxide | 0.3 | parts |

| | |
|---|---|
| Alcogum L-251 (Acrylate Thickener) | as needed for initial viscosity |
| | 30,000-35,000 cps |

In addition, a PVC plastisol-type adhesive having the composition given in Table 2 was tested as a Secondary Adhesive Formulation 2 and as the outer backing layer of each tile sample.

TABLE 2
PVC Secondary Adhesive Formulation
#2 and Outer Layer Formulation

| Components | Tradename | Supplier | PHR |
|---|---|---|---|
| PVC Dispersion Resin | Formolon F28 | Formosa Chemicals | 70 |
| PVC Blending Resin | Formolon F260 | Formosa Chemicals | 30 |
| Plasticizer | Eastman 168 | Eastman Chemical | 90 |
| Wetting Agent | Disperplast 1142 | Byk | 2.5 |
| Viscosity Depressant | Viscobyk 5125 | Byk | 1 |
| Heat Stabilizer | Plastistab | AM Stabilizer | 1.5 |
| Carbon Black | Monarch 120 | Cabot Corp | 1 |
| Calcium Carbonate Filler | CC-103 | Imerys | 250 |

The above PVC formulation had a finished viscosity of 11,500 cps.

All viscosity values cited herein were measured by Brookfield RVF Viscometer at room temperature (21° C.) and 20 rpm.

### Example 1 (Control)

Using Pre-coat Formulation #1 and Pre-coat Binder #1, the carpet precursor was coated with pre-coat adhesive and then dried in an oven at 300° F. (149° C.) for 8 minutes. The resulting dried adhesive on the back of the carpet had a weight of 27 oz/sq yd. The PVC plastisol compound described in Table 2 was applied to a piece of fiberglass scrim which weighed 1.7 oz/sq yd. The PVC plastisol/scrim layers were then applied to the precoated carpet sample such that the PVC plastisol and dried precoat compound were in contact with each other. This composite of materials was placed in an oven at 300° F. (149° C.) for 10 minutes in order to fully fuse the PVC plastisol compound and to achieve the needed strength and adhesion properties. 28 oz/sq yd of the PVC plastisol compound was used in this example as the secondary adhesive layer.

Next, the composite carpet sample had 60 mils of the PVC plastisol described in Table 2 applied to the fiberglass scrim in order to form the outer backing layer. This sample was placed back in the oven for 10 minutes at 300° F. (149° C.) in order to fully fuse the PVC plastisol layer to achieve the needed strength and toughness properties.

Details of the carpet sample and of the subsequent measurements of the tuft bind strength and delamination strength of the outer backing layer are given in Table 2.

### Examples 2 to 8 (Inventive)

A series of additional carpet tile samples were prepared having the composition shown in Table 2. Moreover, in these samples, the emulsion pre-coat compound was applied to the back of the carpet precursor (primary backing layer) but not immediately dried. In a second step, an emulsion based secondary adhesive was applied to a fiberglass scrim. In a third step, the precoated carpet and the coated scrim were joined together to form a composite in such a way that the wet precoat compound and the wet secondary adhesive were in contact with each other. This composite was then dried in the oven at 300° F. (149° C.) for 10 minutes with a weight on top of them to insure that the two liquid polymers dried while in contact with each other. After this 10 minute period, the weight was removed that the samples were placed back in the oven for another 10 minutes at 300° F. (149° C.) to insure that the samples were properly dried. In most of the examples, the polymer used in the precoat is also the same polymer used in the secondary adhesive formulation. But binders do not have to be the same and there could be performance reasons to have different emulsions binders used in the precoat compound versus what is used in the secondary adhesive compound—as can be seen in Example 4 which used two different vinyl acetate/ethylene copolymers.

The results of the subsequent measurements of the tuft bind strength and delamination strength of the outer backing layer are given in Table 3. In most cases, the tuft-bind strength approached or exceeded the value obtained with the control sample. In addition, the PVC plastisol outer backing layer could not be physically separated from any of the samples except for Example 7 where a styrene/butadiene copolymer was used for both the pre-coat binder and the secondary adhesive polymer. SB copolymers are known to have poor adhesion to PVC plastisol materials so these results were not surprising. For this reason, the results of the dimensional stability tests given in Tables 4 and 5 do not include the sample of Example 7.

TABLE 3

| | Pre-Coat | | Pre-Coat | Secondary | Secondary | Secondary | Tuft Bind | Outer Backing Layer |
|---|---|---|---|---|---|---|---|---|
| | Adhesive | Pre-Coat | Add-on | Adhesive | Adhesive | Add-on | Values | Delamination |
| Example | Formulation | Polymer | Wt | Formulation | Polymer | Weight | (lbs force) | Properties |
| #1 | #1 | #1 | 27 oz/sq yd | #2 | PVC | 28 oz/sq yd | 8.6 | Excellent - could not |
| | | | | | Plastisol | | | separate PVC layer |
| | | | | | | | | from the glass scrim |
| #2 | #1 | #1 | 25 oz/sq yd | #1 | #2 | 15 oz/sq yd | 8.8 | Excellent - could not |
| | | | | | | | | separate PVC layer |
| | | | | | | | | from the glass scrim |
| #3 | #1 | #1 | 27 oz/sq yd | #1 | #1 | 21 oz/sq yd | 9.1 | Excellent - could not |
| | | | | | | | | separate PVC layer |
| | | | | | | | | from the glass scrim |
| #4 | #1 | #1 | 27 oz/sq yd | #1 | #2 | 22 oz/sq yd | 9.5 | Excellent - could not |
| | | | | | | | | separate PVC layer |
| | | | | | | | | from the glass scrim |
| #5 | #1 | #3 | 26 oz/sq yd | #1 | #3 | 20 oz/sq yd | 7.6 | Excellent - could not |
| | | | | | | | | separate PVC layer |
| | | | | | | | | from the glass scrim |
| #6 | #1 | #5 | 27 oz/sq yd | #1 | #5 | 20 oz/sq yd | 10.8 | Excellent - could not |
| | | | | | | | | separate PVC layer |
| | | | | | | | | from the glass scrim |
| #7 | #1 | #6 | 27 oz/sq yd | #1 | #6 | 20 oz/sq yd | 10.2 | Poor - the PVC layer |
| | | | | | | | | easily separated from |
| | | | | | | | | the glass scrim |
| #8 | #2 | #1 | 9 oz/sq yd | #1 | #2 | 21 oz/sq yd | 11.2 | Excellent - could not |
| | | | | | | | | separate PVC layer |
| | | | | | | | | from the glass scrim |
| #9 | #1 | #4 | 27 oz/sq yd | #1 | #4 | 21 oz/sq yd | 9.3 | Excellent - could not |
| | | | | | | | | separate PVC layer |
| | | | | | | | | from the glass scrim |

TABLE 4

| | Unconditioned | | | | | |
|---|---|---|---|---|---|---|
| | Cycle 1 | Cycle1 | Cycle 2 | Cycle 2 | Cycle 3 | Cycle3 |
| Example | L | R | L | R | L | R |
| #1 | 2.5 | 2.5 | 1.5 | 2 | 1 | 1.5 |
| #2 | 1 | 3 | 1 | 2 | 1.5 | 2 |
| #3 | 1 | 1.5 | 0 | 0.5 | 0 | 0 |
| #4 | 0.5 | 1 | 0 | 0 | 0 | 0 |
| #5 | 0 | 0 | 0 | 0 | 0 | 0 |
| #6 | 0 | 0 | 0* | 0* | 0* | 0* |
| #8 | 0.5 | 0 | 0.5 | 0.5 | 0.5 | 0 |
| #9 | 0.5 | 0.5 | 0 | 0.5 | 0 | 0 |

*denotes samples which domed

TABLE 5

| | Conditioned | | | | | |
|---|---|---|---|---|---|---|
| | Cycle 1 | Cycle 1 | Cycle 2 | Cycle 2 | Cycle 3 | Cycle 3 |
| Example | L | R | L | R | L | R |
| #1 | 1 | 2 | 1 | 2 | 1 | 2 |
| #2 | 1 | 3 | 1 | 2.5 | 1 | 3 |
| #3 | 0.5 | 1 | 0 | 1 | 0.5 | 1 |
| #4 | 0 | 1 | 0 | 0.5 | 0 | 1 |
| #5 | 0 | 0 | 0 | 0.5 | 0 | 0 |
| #6 | 0 | 0 | 0* | 0* | 0* | 0* |
| #8 | 1 | 0.5 | 1 | 1 | 1 | 1.5 |
| #9 | 0.5 | 0 | 0.5 | 0.5 | 0.5 | 0.5 |

The examples demonstrate that the novel backing system described herein can provide tuft bind with similar or significantly improved performance compared to the standard process being used today. In addition, the dimensional stability testing indicates that all of the binders tested have equal or much improved dimensional stability properties compared to the sample made using the standard process employed in the industry today. All of these samples with improved tuft bind properties and improved dimensional stability are achieved using lower coating weights.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A carpet tile comprising:
(i) a primary backing layer comprising a flexible substrate with fiber tufts extending through and from one surface of the substrate to define, in use, the upper wear surface of the tile;
(ii) a pre-coat adhesive layer formed from an aqueous copolymer dispersion provided on the opposite surface of the primary backing substrate and securing the fiber tufts to the substrate;
(iii) a secondary adhesive layer formed from an aqueous copolymer dispersion provided on the pre-coat adhesive layer;
(iv) a fiberglass scrim secured to the secondary adhesive layer; and
(v) an outer backing or cap layer covering the fiberglass scrim.

2. The carpet tile of claim 1, wherein each of the pre-coat adhesive layer and the secondary adhesive layer is formed from an aqueous dispersion of at least one of a vinyl ester copolymer, an acrylate copolymer, a vinyl ester/acrylate copolymer, a styrene-acrylate copolymer, an acrylic-butadiene copolymer and a styrene-butadiene copolymer.

3. The carpet tile of claim 1, wherein at least one of the pre-coat adhesive layer and the secondary adhesive layer is formed from an aqueous dispersion of a copolymer of vinyl acetate and ethylene formed by emulsion polymerization.

4. The carpet tile of claim 1, wherein each of the pre-coat adhesive layer and the secondary adhesive layer is formed from an aqueous dispersion of a copolymer of vinyl acetate and ethylene formed by emulsion polymerization.

5. The carpet tile of claim 1, wherein the outer backing layer comprises one or more of polyvinyl chloride, bitumen, an extruded polyolefin and polyurethane.

6. A method of manufacturing a carpet tile, the method comprising:
(a) providing a primary backing layer comprising a flexible substrate with fiber tufts extending through and from one surface of the substrate to define, in use, the upper wear surface of the tile;
(b) applying a pre-coat adhesive in liquid form to the opposite surface of the flexible substrate;
(c) while the pre-coat adhesive is still in liquid form, applying a water-based secondary adhesive in liquid form and a fiberglass scrim to the pre-coat adhesive on the primary backing layer;
(d) drying the pre-coat adhesive and the secondary adhesive; and then
(e) applying an outer backing or cap layer to the scrim.

7. The method of claim 6, the pre-coat adhesive comprises a water-based adhesive and step (c) is conducted prior to removal of water from the adhesive.

8. The method of claim 7, the water-based pre-coat adhesive comprises an aqueous dispersion of at least one of a vinyl ester copolymer, an acrylate copolymer, a vinyl ester/acrylate copolymer, a styrene-acrylate copolymer, an acrylic-butadiene copolymer and a styrene-butadiene copolymer.

9. The method of claim 7, the water-based pre-coat adhesive comprises an aqueous dispersion of a copolymer of vinyl acetate and ethylene formed by emulsion polymerization.

10. The method of claim 6, the water-based secondary adhesive comprises an aqueous dispersion of at least one of a vinyl ester copolymer, an acrylate copolymer, a vinyl ester/acrylate copolymer, a styrene-acrylate copolymer, an acrylic-butadiene copolymer and a styrene-butadiene copolymer.

11. The method of claim 6, the water-based secondary adhesive comprises an aqueous dispersion of a copolymer of vinyl acetate and ethylene formed by emulsion polymerization.

12. The method of claim 6, wherein the scrim and the secondary adhesive layer are applied sequentially to the pre-coat adhesive on the primary backing layer.

13. The method of claim 6, wherein the secondary adhesive layer is applied to the scrim before both are applied to the pre-coat adhesive on the primary backing layer.

14. The method of claim 6, wherein the outer backing layer comprises one or more of polyvinyl chloride, bitumen, an extruded polyolefin and polyurethane.
